(19) United States
(12) Patent Application Publication
(10) Pub. No.: US 2026/0196784 A1
(43) Pub. Date: Jul. 9, 2026

(54) THIN-FILM CIRCUIT CONNECTOR ASSEMBLY

(71) Applicant: Molex, LLC, Lisle, IL (US)

(72) Inventors: Michael David Deppe, Batavia, IL (US); Gino Stephen Antonini, New Fairfield, CT (US); Jean-Louis Mendes, Staffanstorp (SE); William Elwood Spink, JR., Zionsville, IN (US)

(21) Appl. No.: 19/441,900

(22) Filed: Jan. 7, 2026

Related U.S. Application Data
(60) Provisional application No. 63/743,235, filed on Jan. 9, 2025.

(51) Int. Cl. H01R 24/54; H01R 12/70

(52) U.S. Cl. CPC H01R 24/542; H01R 12/7017

(57) ABSTRACT

A thin-film circuit connector assembly is described that includes a plug module and a receptacle module detachably attachable to the plug module. The plug module includes a first thin-film circuit comprising a first flexible body having a first signal path and at least one first ground path disposed thereon, a first coaxial adaptor assembly comprising a first conductor and a first coaxial adaptor, and a first housing having a first front aperture in which the first conductor is positioned. The receptacle module includes a second thin-film circuit comprising a second flexible body having a second signal path and at least one second ground path disposed thereon, a second coaxial adaptor assembly comprising a second conductor and a second coaxial adaptor, and a second housing having a second front aperture in which the second coaxial adaptor is positioned.

### CROSS-REFERENCE TO RELATED APPLICATION

This application claims the benefit of and priority to U.S. Provisional Application No. 63/743,235 entitled “THIN-FILM CIRCUIT CONNECTOR ASSEMBLY,” the contents of which being incorporated by reference in their entirety herein.

### TECHNICAL FIELD

The present disclosure relates to electrical connectors, and more particularly to a thin-film circuit connector assembly with a locking device for securing a thin-film circuit or like substrate to a connector housing. In some aspects, the thin-film circuit connector assembly may include coaxial components to enable coaxial signal radio-frequency (RF) transmission.

### BACKGROUND

Thin-film connectors have become increasingly important in modern electronic devices due to their ability to provide high-speed signal transmission in compact form factors. However, these connectors present unique challenges in terms of handling and implementation. The delicate nature of thin-film circuits, cables, and like devices make them susceptible to damage during installation and use. The flexible substrate material can easily tear or deform if subjected to excessive force or improper manipulation, potentially compromising the integrity of the signal paths embedded within the circuit, cable, etc.

Furthermore, the process of terminating thin-film circuits to connectors or other components can be particularly demanding. The small size and tight spacing of conductors within thin-film circuits require precise alignment and specialized tooling for proper termination. Technicians often struggle with maintaining consistent and reliable connections, especially in field environments where controlled conditions may not be available. These difficulties can lead to increased installation times, higher failure rates, and potential reliability issues in the final assembly.

### BRIEF SUMMARY

According to an aspect of the present disclosure, a connector assembly is provided that includes a plug module. The plug module includes a thin-film circuit comprising a flexible body having a signal path and at least one ground path disposed thereon. The plug module also includes a coaxial adaptor assembly comprising a conductor and a coaxial adaptor, where the signal path of the thin-film circuit is conductively coupled to the conductor. The plug module further includes a housing having a front aperture in which the conductor is positioned, the housing comprising a mating end and a termination end. The plug module additionally includes a latch pivotably coupled to the housing at the termination end, the latch being adjustable between an open position in which the thin-film circuit is releasable from the housing, and a closed position in which the latch applies a compression force against the thin-film circuit to secure the thin-film circuit to the housing.

The latch may comprise pivot projections positioned on opposing sides thereof, and the housing may comprise apertures configured to receive the pivot projections to enable rotational movement of the latch between the open position and the closed position. The housing may comprise retention members positioned on opposing sides of the housing, the retention members being configured to retain the latch in the closed position. The latch may comprise flanges positioned on opposing sides thereof, and the housing may comprise flange apertures configured to receive the flanges when the latch is in the closed position.

The connector assembly may further comprise a coaxial support positioned through a bottom insert aperture on a bottom of the housing, the coaxial support extending into the front aperture and providing support for the coaxial adaptor. The coaxial support may comprise insert tabs configured to form a snap connection with the housing. The coaxial adaptor assembly may comprise a signal terminal extending from the conductor and ground terminals extending from the coaxial adaptor, the signal terminal being conductively coupled to the signal path and the ground terminals being conductively coupled to the at least one ground path. The housing may comprise alignment guides positioned within the front aperture, the alignment guides configured to engage with corresponding features of a receptacle module to facilitate mating of the connector assembly with the receptacle module. The housing may comprise alignment and retention posts extending from a surface of a mating channel positioned at the termination end of the housing, and the flexible body of the thin-film circuit may comprise circuit apertures configured to receive the alignment and retention posts.

According to another aspect of the present disclosure, a connector assembly is provided that includes a receptacle module. The receptacle module includes a thin-film circuit comprising a flexible body having a signal path and at least one ground path disposed thereon. The receptacle module also includes a coaxial adaptor assembly comprising a coaxial adaptor and a conductor receptacle disposed within the coaxial adaptor, where the signal path of the thin-film circuit is conductively coupled to the conductor receptacle, and where the at least one ground path is conductively coupled to the coaxial adaptor. The receptacle module further includes a housing having a front aperture in which the coaxial adaptor is positioned, the housing comprising a mating end and a termination end. The receptacle module additionally includes a latch pivotably coupled to the housing at the termination end, the latch being adjustable between an open position in which the thin-film circuit is releasable from the housing, and a closed position in which the latch applies a compression force against the thin-film circuit to secure the thin-film circuit to the housing.

The conductor receptacle may comprise slots extending annularly around a body thereof, the slots defining compliant fingers configured to form an interference connection with a coaxial adaptor of a plug module when the receptacle module is mated with the plug module. The slots may extend longitudinally along a portion of the conductor receptacle, thereby allowing the compliant fingers to flex radially to accommodate the coaxial adaptor of the plug module. The housing may comprise a mating channel in which a portion of the thin-film circuit is positioned, and the housing may further comprise alignment and retention posts extending from a surface of the mating channel, the alignment and retention posts configured to insert into circuit apertures positioned on opposing sides of the flexible body of the thin-film circuit. The housing may comprise a housing latch configured to releasably insert into a housing latch aperture of a plug module to retain a coupling between the receptacle module and the plug module. The housing may comprise an elongated tubular projection portion having the coaxial adaptor assembly positioned therein, the elongated tubular projection portion configured to mate with a front aperture of a plug module.

According to another aspect of the present disclosure, a connector assembly is provided. The connector assembly includes at least one of a plug module and a receptacle module. The plug module includes a first thin-film circuit comprising a first flexible body having a first signal path and at least one first ground path disposed thereon. The plug module also includes a first coaxial adaptor assembly comprising a conductor and a first coaxial adaptor, where the first signal path is conductively coupled to the conductor. The plug module further includes a first housing having a first front aperture in which the conductor is positioned.

The connector assembly also includes the receptacle module, where the receptacle module is detachably attachable to the plug module. The receptacle module includes a second thin-film circuit comprising a second flexible body having a second signal path and at least one second ground path disposed thereon. The receptacle module also includes a second coaxial adaptor assembly comprising a conductor receptacle and a second coaxial adaptor, where the second signal path is conductively coupled to the conductor receptacle. The receptacle module further includes a second housing having a second front aperture in which the second coaxial adaptor is positioned, the second coaxial adaptor configured to mate with the first coaxial adaptor to establish electrical communication between the conductor and the conductor receptacle. At least one of the plug module and the receptacle module comprises a latch pivotably coupled to a respective housing, the latch being adjustable between an open position in which a respective thin-film circuit is releasable from the respective housing, and a closed position in which the latch applies a compression force against the respective thin-film circuit to secure the respective thin-film circuit to the respective housing.

The second coaxial adaptor may comprise compliant fingers configured to form an interference connection with the first coaxial adaptor when the plug module is mated with the receptacle module. The second housing may comprise a housing latch configured to releasably engage with a housing latch aperture on the first housing to retain the plug module and the receptacle module in a mated configuration. The first housing may comprise alignment guides positioned within the first front aperture, and the second housing may comprise guide slots configured to receive the alignment guides to facilitate alignment of the plug module with the receptacle module during mating. The latch may comprise pivot projections positioned on opposing sides thereof configured to nest or be received within corresponding apertures on the respective housing, and the respective housing may comprise retention members configured to retain the latch in the closed position.

The foregoing general description of the illustrative embodiments and the following detailed description thereof are merely example aspects of the disclosure and are not restrictive.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a front perspective view of a plug module of a connector assembly according to various embodiments of the present disclosure.

FIG. 2 illustrates another front perspective view of the plug module of FIG. 1 according to various embodiments of the present disclosure.

FIG. 3 illustrates a rear perspective view of the plug module of FIG. 1 according to various embodiments of the present disclosure.

FIG. 4 illustrates another rear perspective view of the plug module of FIG. 1 according to various embodiments of the present disclosure.

FIG. 5 shows a rear view of the plug module of FIG. 1 according to various embodiments of the present disclosure.

FIG. 6A shows a top perspective view of the plug module of FIG. 1 with a housing and a locking device thereof omitted from view according to various embodiments of the present disclosure.

FIG. 6B is a partially transparent bottom perspective view of the plug module of FIG. 1 according to various embodiments of the present disclosure.

FIG. 7 is a top cross-section view of a portion of the plug module of FIG. 1 according to various embodiments of the present disclosure.

FIG. 8 is a perspective cross-section view of a portion of the plug module of FIG. 1 according to various embodiments of the present disclosure.

FIG. 9 shows a rear view of the plug module of FIG. 1 with a locking device in a first, released position according to various embodiments of the present disclosure.

FIG. 10 illustrates a rear view of the plug module of FIG. 1 with a locking device in a second, secured position according to various embodiments of the present disclosure.

FIG. 11 is a front perspective view of a housing and a locking device of the plug module of FIG. 1 according to various embodiments of the present disclosure.

FIG. 12 is a front view of a housing and a locking device of the plug module of FIG. 1 according to various embodiments of the present disclosure.

FIG. 13 is a top view of a housing and a locking device of the plug module of FIG. 1 according to various embodiments of the present disclosure.

FIG. 14 is a side view of a housing and a locking device of the plug module of FIG. 1 shown in a first, released position according to various embodiments of the present disclosure.

FIG. 15 is a side view of a housing and a locking device of the plug module of FIG. 1 shown in a second, secured position according to various embodiments of the present disclosure.

FIG. 16 illustrates a front perspective view of a plug module of the connector assembly according to various embodiments of the present disclosure.

FIG. 17 illustrates a rear perspective view of the plug module of FIG. 16 according to various embodiments of the present disclosure.

FIG. 18 illustrates a bottom perspective view of the plug module of FIG. 16 according to various embodiments of the present disclosure.

FIG. 19 illustrates another bottom perspective view of the plug module of FIG. 16 with a housing of the plug module omitted for explanatory purposes according to various embodiments of the present disclosure.

FIGS. 20 and 21 illustrate top and bottom perspective views, respectively, of a coaxial adaptor assembly of the plug module of FIG. 16 according to various embodiments of the present disclosure.

FIG. 22 illustrates a top perspective view of a receptacle module of the connector assembly according to various embodiments of the present disclosure.

FIG. 23 illustrates a front perspective view of the receptacle module of FIG. 22 according to various embodiments of the present disclosure.

FIG. 24 illustrates a bottom perspective view of the receptacle module of FIG. 22 according to various embodiments of the present disclosure.

FIG. 25 illustrates a housing and a coaxial adaptor assembly of the receptacle module of FIG. 22 according to various embodiments of the present disclosure.

FIGS. 26 and 27 illustrate top and bottom perspective views, respectively, of a coaxial adaptor assembly of the receptacle module of FIG. 22 according to various embodiments of the present disclosure.

FIGS. 28 and 29 illustrate a termination region in which a thin-film circuit is terminated to a housing of the receptacle module of FIG. 22 according to various embodiments of the present disclosure.

FIGS. 30 and 31 illustrate side views of the receptacle module of FIG. 22 illustrating a latch positioned in open and locked states, respectively, according to various embodiments of the present disclosure.

FIG. 32 illustrates another side view of the receptacle module of FIG. 22 showing the latch positioned in a locked state according to various embodiments of the present disclosure.

FIG. 33 is another top perspective view of the receptacle module of FIG. 22 according to various embodiments of the present disclosure.

FIG. 34 shows the connector assembly, where the plug module is detachably coupled to the receptacle module according to various embodiments of the present disclosure.

FIG. 35 is an identical view of FIG. 34 with housings thereof omitted to display connections between respective coaxial adaptors of the plug module and the receptacle module according to various embodiments of the present disclosure.

### DETAILED DESCRIPTION

The present disclosure relates to a thin-film circuit connector assembly according to various embodiments. Thin-film substrates (e.g., thin-film circuits, thin-film cables, and like devices) have gained prominence in various electronic applications due to their unique properties and advantages. These devices typically include a thin, flexible substrate material with conductive traces or paths embedded within or printed on the surface. The substrate may be made from materials such as polyimide, polyester, or other flexible polymers, allowing the device to bend and conform to tight spaces within electronic devices including, but not limited to, automotive vehicles, airplanes, and so forth. This flexibility, combined with their low profile and lightweight nature, makes thin-film substrates ideal for use in compact and densely packed electronic assemblies.

In some cases, thin-film substrates can offer superior electrical performance compared to traditional wire-based cables. The controlled impedance characteristics and reduced crosstalk between signal paths in thin-film substrates can allow for higher data transmission rates and quality signal integrity. Additionally, the ability to create complex routing patterns and incorporate multiple layers within the thin-film structure can enable engineers to optimize signal paths and reduce overall cable length, potentially improving system performance.

However, thin-film substrates can present several challenges in terms of handling, installation, and long-term reliability. The delicate nature of the thin substrate material can make these substrates susceptible to physical damage during assembly or use. Bending or folding the substrate beyond its specified limits can result in cracking or delamination of the conductive traces, potentially leading to open circuits or intermittent connections. Furthermore, the thin profile of these substrates can make them more vulnerable to environmental factors such as moisture, temperature fluctuations, and mechanical stress, which may impact their long-term performance and reliability in certain applications.

In some cases, the process of terminating thin-film substrates can require specialized equipment and techniques to ensure proper alignment and contact between the conductive traces and the termination points, while connecting thin-film substrates to other connectors may present challenges in achieving consistent and reliable electrical connections due to the delicate nature of the thin-film structure.

Accordingly, various embodiments are described herein for a connector assembly that features a thin-film circuit connector assembly such that the thin-film circuit connector assembly can be coupled to other external connectors. The connector assembly can include one or both of a plug module and a receptacle module, each having a thin-film circuit connector assembly, a connector housing, and a locking device. The thin-film circuit connector assembly can include a coaxial adaptor comprising a conductor, and a thin-film substrate having a signal path conductively coupled to the conductor of the coaxial adaptor. It is understood, however, that other types of connections can be employed other than coaxial connections. The thin-film substrate can include a thin-film circuit, for example.

The housing includes a front aperture in which the conductor of the coaxial adaptor is positioned. The locking device, which can be movably coupled to the housing, can be adjustable between a first position in which the thin-film circuit is secured to the housing, and a second position in which the thin-film circuit is releasable from the housing. In some aspects, the connector assembly may provide a secure and reliable connection for thin-film circuits, potentially reducing installation times, failure rates, and reliability issues associated with conventional connector designs.

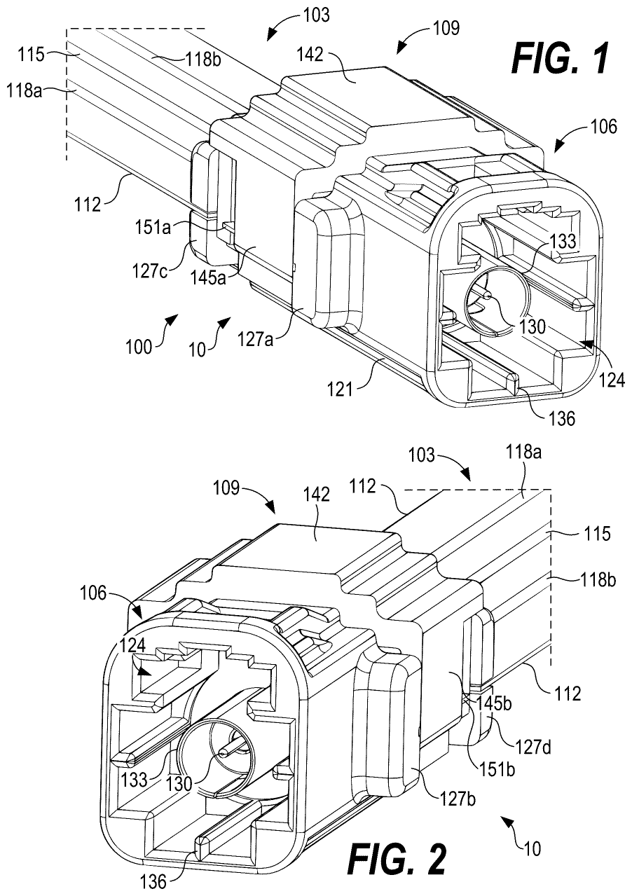

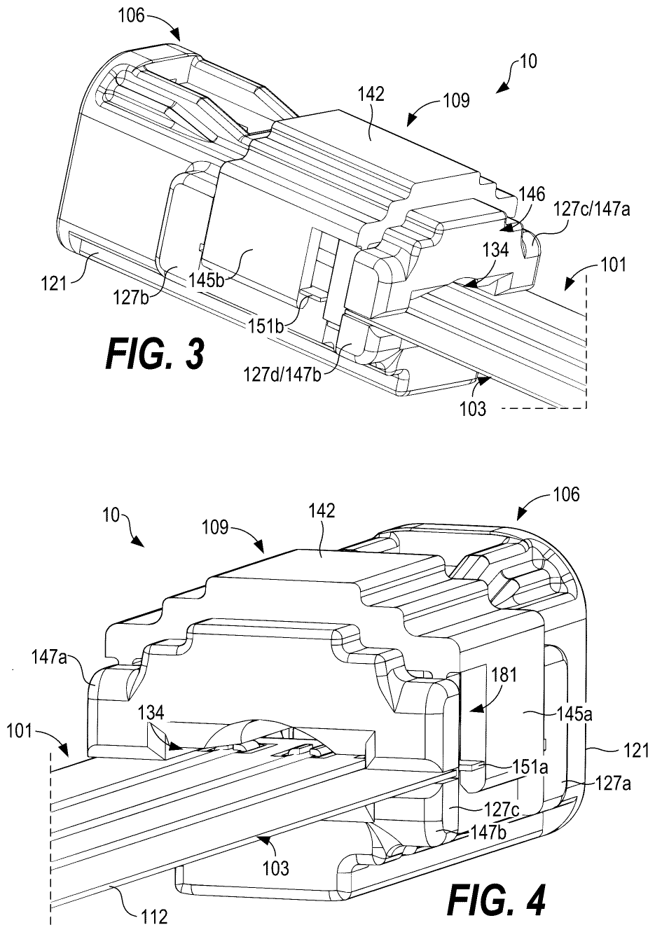

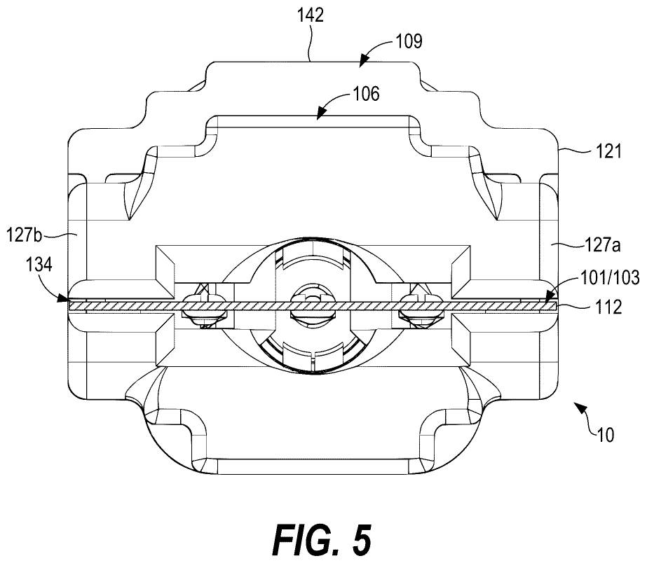

Turning now to the drawings, FIGS. 1 and 2 illustrate front perspective views of a plug module 10 of a connector assembly 100 according to various embodiments of the present disclosure. FIGS. 3 and 4 show a rear perspective view of the plug module 10 of the connector assembly 100. FIG. 5 shows a rear view of the plug module 10 of the connector assembly 100 according to various embodiments of the present disclosure.

Referring among FIGS. 1-5, the plug module 10 of the connector assembly 100 can include a thin-film circuit connector assembly 101, a connector housing 106 (or “housing 106”), and a locking device 109, among other components as will be described. Beginning with the thin-film circuit connector assembly 101, the thin-film circuit connector assembly 101 can include a thin-film substrate, such as a thin-film circuit 103, having a thin-film circuit body 112 (or “body 112”). The thin-film circuit 103, via the body 112, can provide a signal path 115. In some embodiments, radio-frequency (RF) signals can be communicated along the signal path 115, although in other implementations, direct current (DC) signals can be communicated thereupon. The body 112 of the thin-film circuit 103 can be flexible in some implementations and can have elongated top and bottom surfaces. Thus, due to the flexible nature of the thin-film circuit 103, the connector assembly 100 can be optimal for automotive, aeronautical, and like applications. While various embodiments describe a substrate embodying a thin-film circuit 103, it is understood that the principles described herein can be applied to other flexible substrates, such as thin-film ribbon cables and so forth.

In some embodiments, the body 112 of the thin-film circuit 103 can further include ground paths, such as a first ground path 118a and a second ground path 118b (collectively “ground paths 118”). In the embodiments shown, the ground paths 118 can be disposed on opposing sides of the signal path 115, such that the signal path 115 is positioned or sandwiched between the ground paths 118. Such arrangement can provide improved signal integrity (SI) and other performance improvement of the thin-film circuit 103. The signal path 115 and/or the ground paths 118 can be disposed in a layer of the thin-film circuit 103 or, in some implementations, can be printed on a surface of the thin-film circuit 103.

Referring now to the housing 106, the housing 106 of the plug module 10 can include a generally square or rectangular cross-section, featuring rounded or sharp corners in some implementations. However, the disclosure is not limited to these geometries, and various other shapes of cross-sections can be employed. The housing 106 can be formed of an insulator material, such as plastic, and can be injection molded in some implementations. The housing 106 includes a housing body 121 that defines a front aperture 124 at a mating end of the housing 106. A conductor 130 and a coaxial adaptor 133 can be positioned within the front aperture 124, although other types of connectors and connections can be employed. For instance, a multitude of terminal pairs configured for differential signaling can be employed in addition to or in place of the coaxial adaptor 133.

A mating portion of the conductor 130 and the coaxial adaptor 133 can be exposed in the front aperture 124 to facilitate mating the plug module 10 to a receptacle module (not shown). The conductor 130 can be terminated to or otherwise conductively coupled to the signal path 115 of the thin-film circuit 103, as will be discussed. Thus, when the housing 106 of the plug module 10 is coupled to another connector, such as a receptacle module, (not shown) at a mating end of the connector assembly 100, a signal carried upon the signal path 115 of the thin-film circuit 103 can travel through the conductor 130 and to the other connector.

The housing 106 can further include locating features 127a . . . 127d (collectively “locating features 127”), which can include projections extending from a surface of the housing 106 that engage and couple with corresponding features of another connector (not shown). For instance, the locating features 127 can ensure proper fitting and orientation of the connector assembly 100 relative to the other connector. The locating features 127 can also form snap connections with the other connector, or can form other types of connections therewith, such as a friction connection, interference connection, and so forth, while permitting the housing 106 to be removed from the other connector when a predetermined amount of force is applied to the connector assembly 100.

The front aperture 124 can assume various shapes. In the embodiments shown, the front aperture 124 has a top section with a first width, a middle section with a second width, and a bottom section with a third width, where the first width and the third width are equal and both are less than the second width, thereby resembling a t-shaped or cross-shaped aperture. One or more alignment guides 136 can project from respective surfaces of the housing 106 within the front aperture 124. Like the locating features 127, the alignment guides 136 can engage and couple with corresponding guide slots or like features of another connector (not shown). For instance, the alignment guides 136 can slide into or otherwise interface with corresponding guide slots positioned on the other connector.

The locking device 109 is configured to further couple the thin-film circuit 103 to the housing 106. In some embodiments, the locking device 109 permits the thin-film circuit 103 to be detachably coupled to the housing 106, such that the thin-film circuit 103 can be attached and removed therefrom. To this end, the locking device 109 can include a locking device body 142 that straddles the housing 106. The locking device 109 can be transitioned between a first state, shown in FIGS. 1-5, where the locking device 109 secures the thin-film circuit 103 to the housing 106, and a second state, where the locking device 109 is at least partially releasable from the housing 106, as will be described. When in the second state, the thin-film circuit 103 is removable from the plug module 10 and the housing 106 thereof.

The locking device body 142 can include an inverse U-shaped body, in some embodiments. To this end, the locking device body 142 can include a first leg 145a that is configured to align between first and third locating features 127a, 127c, and reside in a groove defined therein. Similarly, the locking device body 142 can include a second leg 145b that is configured to align between second and fourth locating features 127b, 127d, and reside in a groove defined therein.

In some embodiments, the third locating feature 127c and the fourth locating feature 127d are integral with one another and are part of a housing tail stiffener 146 having a top portion 147a and a bottom portion 147b. The top portion 147a and the bottom portion 147b of the housing tail stiffener 146 can project or otherwise extend from the housing 106, and can be slightly separated from one another vertically to define a slot 134. The slot 134 can have a height that closely corresponds to a height of the thin-film circuit 103 to provide a snug fit with the thin-film circuit 103. The thin-film circuit 103 can be positioned in the slot 134, which can be located on a rear end of the housing 106, such that the third locating feature 127c and the fourth locating feature 127d support a termination region of the thin-film circuit 103.

The housing 106 and the locking device 109 may be formed from a variety of polymer or plastic materials. These materials can include, but are not limited to, polyethylene (PE), polypropylene (PP), polyamide (PA), polyoxymethylene (POM), polybutylene terephthalate (PBT), polyethylene terephthalate (PET), polycarbonate (PC), acrylonitrile butadiene styrene (ABS), polyetheretherketone (PEEK), polyphenylene sulfide (PPS), and various blends or composites thereof. In some cases, the materials may be reinforced with glass fibers, carbon fibers, or other additives to enhance mechanical properties such as strength, stiffness, and dimensional stability. The choice of material may depend on factors such as the intended operating environment, mechanical requirements, electrical properties, and cost considerations.

The housing 106 and locking device 109 may be manufactured using various forming processes, with injection molding being one example due to its efficiency and ability to produce complex shapes with high precision. In the injection molding process, the chosen polymer material can be heated until molten and then injected under high pressure into a mold cavity that defines the shape of the part. After cooling and solidification, the part may be ejected from the mold. Other forming methods can also be employed such as compression molding, transfer molding, or extrusion followed by machining. In some cases, multiple components may be overmolded or insert-molded to create integrated assemblies. Post-molding operations such as ultrasonic welding, heat staking, or adhesive bonding can be used to join separate components if needed.

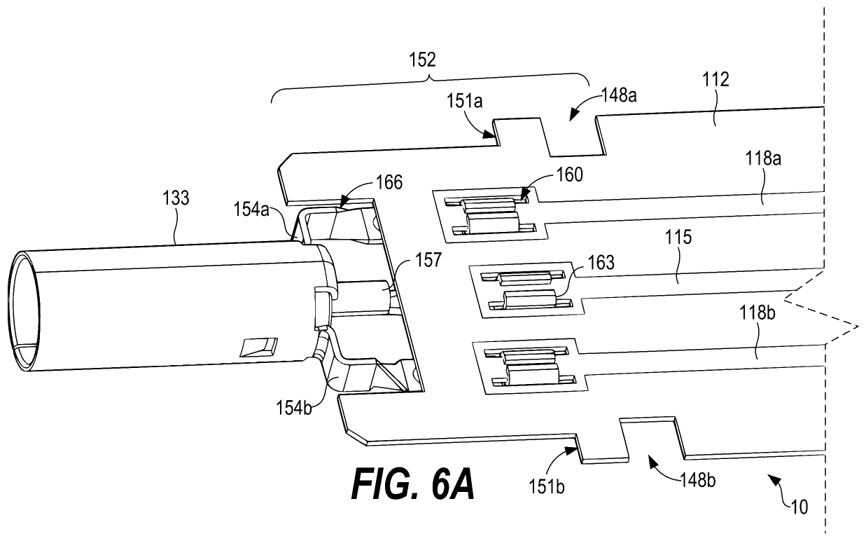

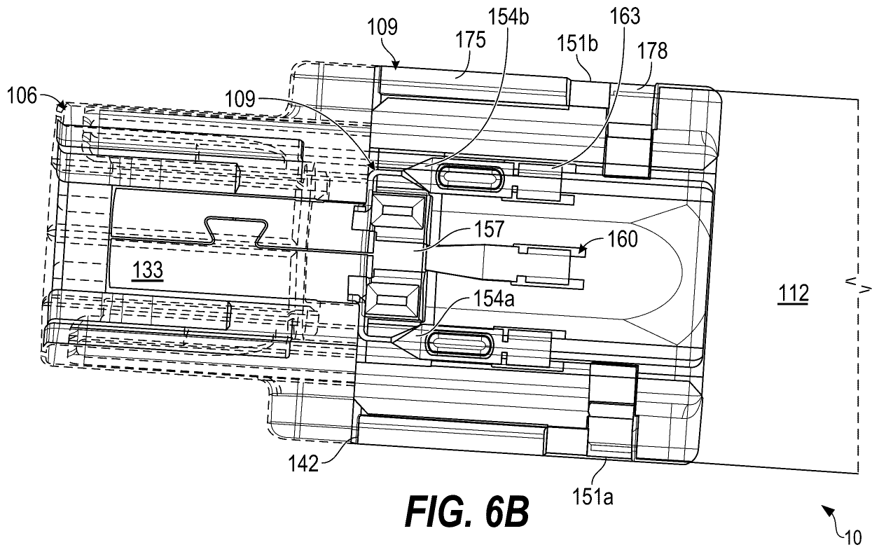

Rear views of the connector assembly 100 are shown in FIGS. 4 and 5. A top perspective view of the thin-film circuit connector assembly is shown in FIG. 6A with the housing 106 and the locking device 109 omitted for explanatory purposes. A partially transparent bottom view of the thin-film circuit connector assembly is shown in FIG. 6B. Referring to FIGS. 4, 5, 6A, and 6B collectively, the body 112 of the thin-film circuit 103 can include side notches 148a, 148b (collectively “side notches 148”) positioned on opposing sides of the body 112. The side notches 148 can be positioned in the body 112 such that the thin-film circuit 103 includes side tabs 151a, 151b (collectively “side tabs 151”) that project from sides of the body 112 proximate the side notches 148.

As shown in FIG. 4 for example, when the locking device 109 is in the secured position relative to the housing 106, the legs 145 of the locking device 109 include a first portion that is positioned in a respective side notch 148 of the thin-film circuit 103, as well as a second portion that is positioned in front of the respective side notch 148. As such, the side tabs 151 are encased between first and second portions of each leg 145 of the locking device 109, which further secures the body 112 of the thin-film circuit 103 to the housing 106.

As shown in FIGS. 6A and 6B, the coaxial adaptor 133 can include a generally circular housing having a conductor 130 positioned therein. The coaxial adaptor 133 can have three couplers extending therefrom including, but not limited to, a first ground coupler 154a, a second ground coupler 154b, and a signal coupler 157 positioned between the first ground coupler 154a and the second ground coupler 154b (collectively “ground couplers 154”). Like the coaxial adaptor 133 and the conductor 130, the first ground coupler 154a, the second ground coupler 154b, and the signal coupler 157 can be formed of a conductive material and can be selectively plated using a conductive material (e.g., gold, silver, copper, and so forth) to enhance conductivity.

The first ground coupler 154a, the second ground coupler 154b, and the signal coupler 157 can be terminated or otherwise electrically connected to the first ground path 118a, the second ground path 118b, and the signal path 115 of the thin-film circuit 103, respectively. To this end, the thin-film circuit 103 can include trace apertures 160 positioned in each of the first ground path 118a, the second ground path 118b, and the signal path 115 of the thin-film circuit 103. The first ground coupler 154a, the second ground coupler 154b, and the signal coupler 157 can include crimping portions 163 extending through the trace apertures 160 that can be crimped to couple the first ground coupler 154a, the second ground coupler 154b, and the signal coupler 157 to the first ground path 118a, the second ground path 118b, and the signal path 115, respectively. The first ground coupler 154a and/or the second ground coupler 154b can include bends 166 that orient the respective coupler 154 from a vertical orientation, as coupled to the coaxial adaptor 133, to a horizontal orientation for coupling to the thin-film circuit 103. Thus, the crimping portions 163 are aligned in a common plane as the thin-film circuit 103 or the body 112 thereof.

In various embodiments, the thin-film circuit 103 includes multiple layers of materials. For example, the thin-film circuit 103 can include a base substrate layer that provides structural support and flexibility. This substrate layer can be formed of materials such as polyimide, polyester, or other flexible polymers that offer durability and resistance to environmental factors. In some implementations, the thin-film circuit 103 can incorporate one or more conductive layers. These conductive layers can be formed from materials such as copper, aluminum, silver, or gold, and can be deposited or etched onto the substrate to create the signal path 115 and ground paths 118. The thickness and composition of these conductive layers can be varied to meet specific electrical performance requirements.

The thin-film circuit 103 can also include one or more insulating layers. These layers can be formed of various dielectric materials such as polyimide, polyethylene, or fluoropolymers, and can serve to electrically isolate different conductive layers or provide protection from external interference. In some cases, these insulating layers can be designed with specific dielectric constants to control impedance and signal propagation characteristics.

In some embodiments, the thin-film circuit 103 can feature additional functional layers. These can include adhesive layers to bond different materials together, shielding layers to provide electromagnetic interference (EMI) protection, or specialized coatings to enhance chemical resistance or provide specific surface properties.

The thin-film circuit 103 can also incorporate reinforcement layers in certain areas, such as the termination region 152. These reinforcement layers can be composed of materials with higher rigidity or strength, such as polyester or aramid fibers, to provide additional support and durability in areas subject to mechanical stress. In some implementations, the thin-film circuit 103 can include surface finish layers, which can include thin coatings applied to the outermost layers of the cable to provide specific properties such as improved wear resistance, enhanced chemical compatibility, or reduced friction for easier installation. The composition and arrangement of these layers within the thin-film circuit 103 can be customized to meet specific application requirements, potentially allowing for optimized electrical performance, mechanical properties, and environmental resistance in a compact and flexible package.

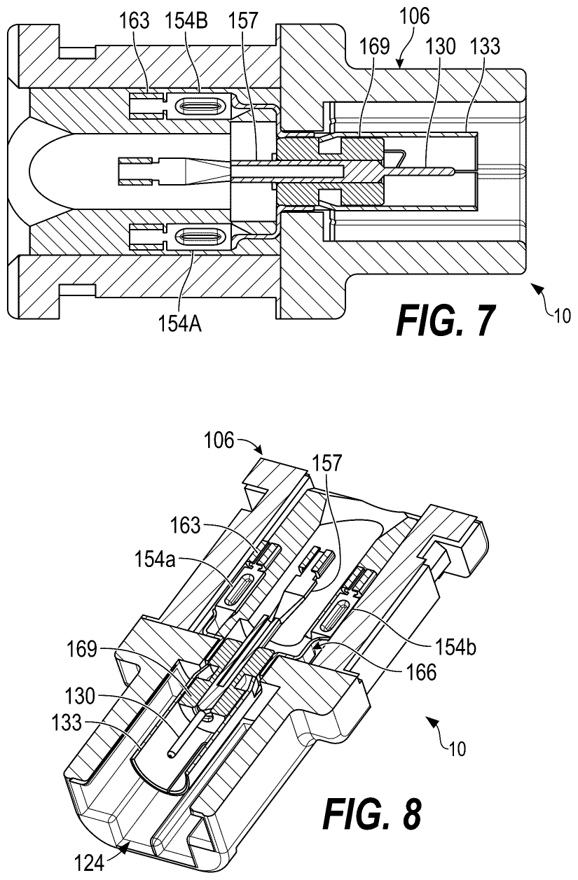

FIGS. 7 and 8 illustrate cross-section views of a portion of the connector assembly 100 according to various embodiments of the present disclosure. Notably, the thin-film circuit 103 is omitted from these views for clarity. The housing 106 encloses various internal components of the connector assembly 100. More specifically, the coaxial adaptor 133 can be positioned centrally within the housing 106. The coaxial adaptor 133 includes a conductor 130 at its core, surrounded by a coaxial insulator 169 and/or the coaxial adaptor 133 where, in some embodiments, the conductor 130 extends the length of the coaxial adaptor 133. The signal coupler 157 is flanked by two ground couplers 154a and 154b, where each of the couplers 154a, 154b, and 157 can include crimping portions 163 that may allow for connection to corresponding conductive paths. For instance, a pair of trace apertures 160 can be positioned for each path on the thin-film circuit 103, where a pair of crimping portions 163 can be positioned through the pair of trace apertures 160 and crimped thereto. A perimeter of the trace apertures 160 can be conductive and, as such, a crimping of the crimping portions 163 can create a permanent conductive coupling between the coaxial adaptor 133 and the thin-film circuit 103, as illustrated in FIGS. 6A and 6B.

Referring again to FIG. 7, the ground couplers 154a and 154b can each incorporate a bend 166, which enables a transition from a vertical orientation near the coaxial adaptor 133 to a horizontal orientation within the housing 106. FIG. 7 provides an orthogonal view, showing the alignment of components within the housing 106, and FIG. 8 offers an isometric perspective, illustrating the three-dimensional arrangement of these components within the connector assembly 100. Collectively, these views help demonstrate how the various elements are integrated to form a compact and functional connector assembly.

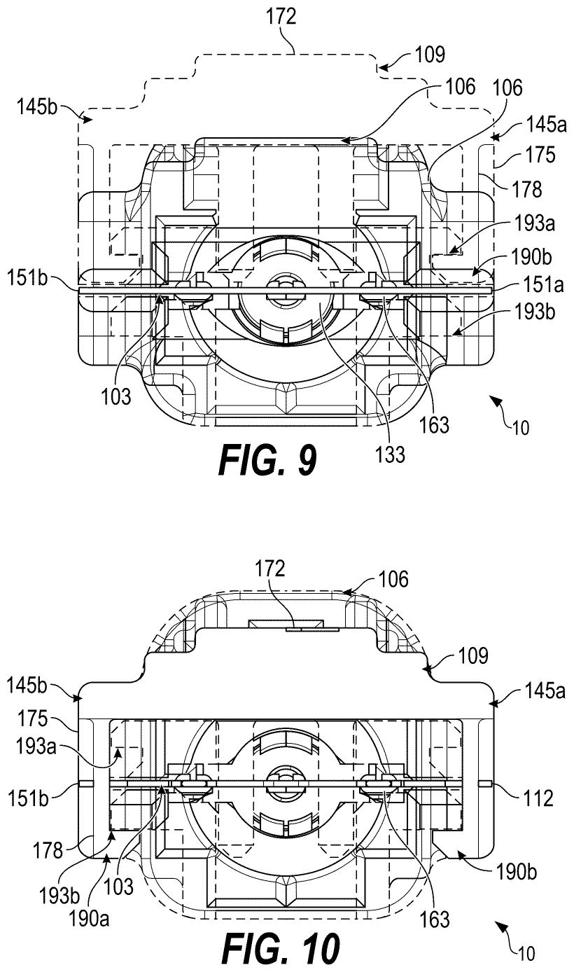

FIGS. 9 and 10 show a rear partially-transparent view of the connector assembly 100 with the locking device 109 in a first, released position (FIG. 9) and a second, secured position (FIG. 10) according to various embodiments of the present disclosure. The locking device 109 can include a first leg 145a positioned on a first side of the housing 106 and a second leg 145b positioned on a second side of the housing 106, such that the locking device 109 straddles two sides of the housing 106. The locking device 109 can be symmetrical in some embodiments. A connecting member 172 of the locking device 109 can couple the first leg 145a and the second leg 145b to one another. The connecting member 172 can include a stepped surface to reduce material and make the connector assembly 100 easy to grip and manipulate. When in a secured state, the connecting member 172 can be positioned on a top surface on the housing 106, where a height of the connecting member 172 relative to the top surface of the housing 106 can be adjustable.

Referring to FIGS. 9-15 collectively, each leg 145 of the locking device 109 can include a first leg portion 175 and a second leg portion 178 separated by a leg aperture 181. When adjusting the locking device 109 from the first, unsecured position (shown in FIGS. 9, 12, and 15) to the second, secured position (shown in FIGS. 10, 13, 14, and 15), the locking device 109 can be pushed downwards, where the tabs 151 of the thin-film circuit 103 will align with the leg aperture 181, enabling the first leg portion 175 and the second leg portion 178 to slide down on opposing sides of the tabs 151. As such, the first leg portion 175 of each of the legs 145 can prevent movement of the tabs 151 in a rearward direction, the second leg portion 178 can prevent movement of the tabs 151 in a forward direction, and the connecting member 172 can prevent movement of the tabs 151 in an upward direction.

Moreover, the termination region 152 of the thin-film circuit 103 can be positioned within a cable slot 184 in the housing 106. The termination region 152 can include a stiffener (not shown), which can be a polymer stiffener or like stiffener disposed on one or more layers of the body 112 of the thin-film circuit 103, as can be appreciated. The stiffener can protect the integrity of the termination region 152 of the thin-film circuit 103, as it is the region of the thin-film circuit 103 most likely to experience stresses, bending, and so forth.

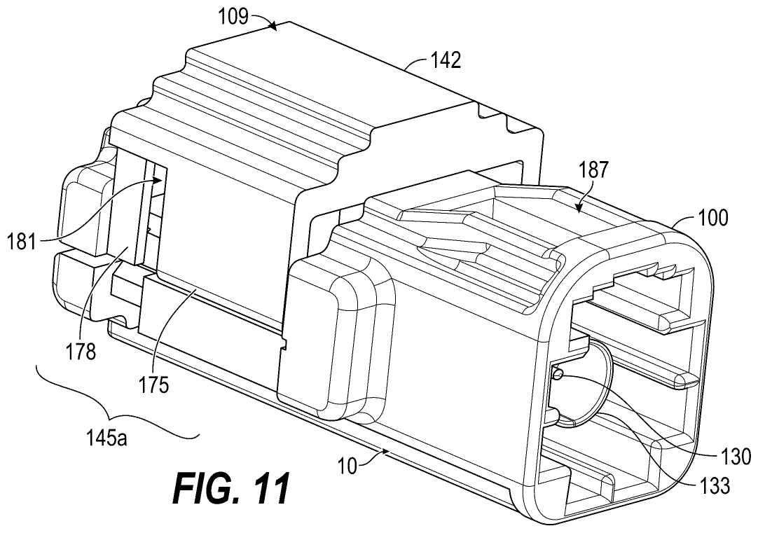

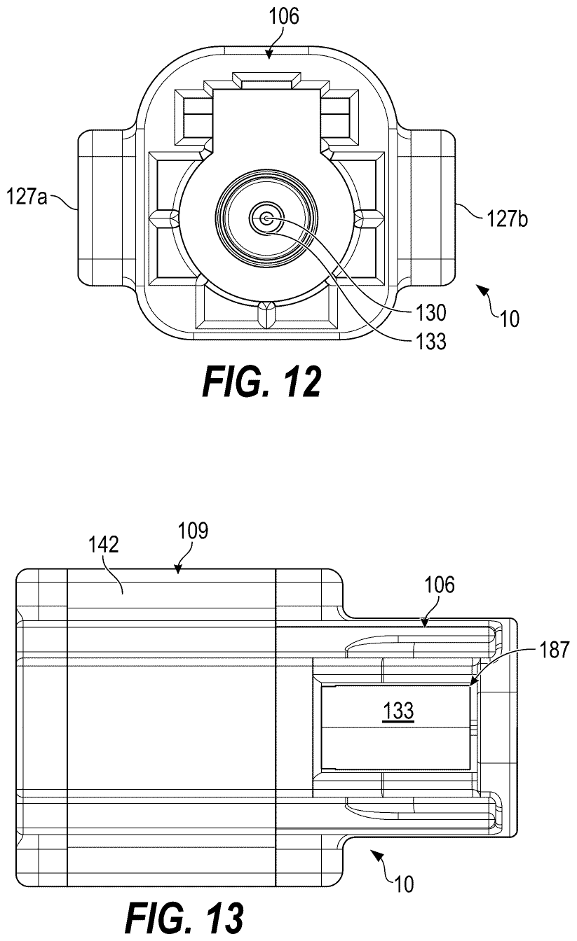

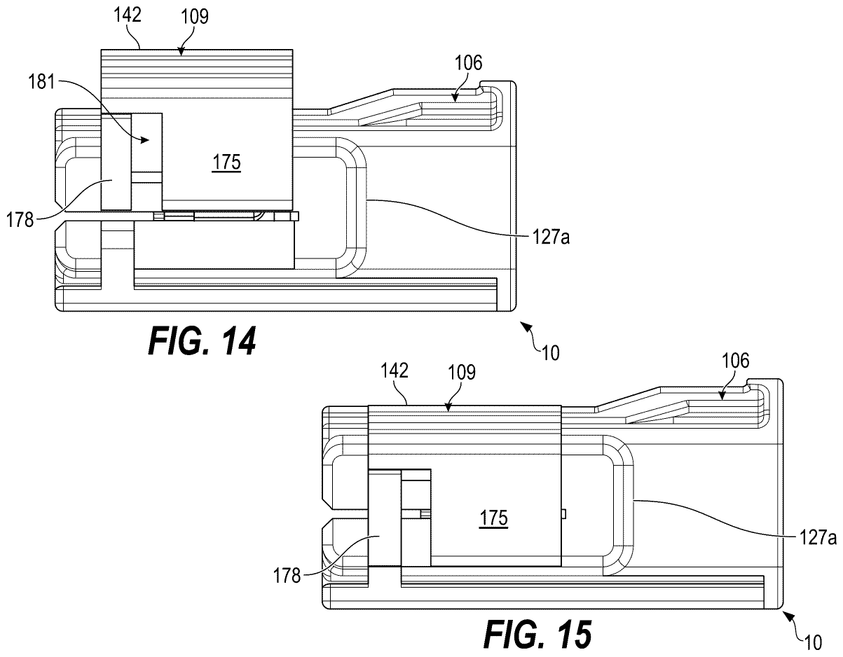

FIG. 11 is a front perspective view, FIG. 12 is a front view, and FIG. 13 is a top view of the housing 106 and the locking device 109 of the connector assembly 100, respectively. FIGS. 14 and 15 are side views of the housing 106 and the locking device 109, where FIG. 14 shows the locking device 109 is in an unsecured (or open) state and FIG. 15 shows the locking device 109 is in a secured (or closed) state. The thin-film circuit 103 is omitted for explanatory purposes from FIGS. 11-15.

As can be seen in FIGS. 11, 14, and 15, each leg 145 of the locking device 109 includes the first leg portion 175 and the second leg portion 178 separated from one another by the leg aperture 181. When adjusting the locking device 109 from the first, unsecured position, shown in FIG. 14, to the second, secured position, shown in FIG. 15, the locking device 109 can be pushed downwards, where the tabs 151 of the thin-film circuit 103 (not shown) will align with the leg aperture 181, enabling the first leg portion 175 and the second leg portion 178 to slide down on opposing sides of the tabs 151.

In some embodiments, the housing 106 can include a window 187 positioned on a top surface of the housing 106. The window 187 can expose the coaxial adaptor 133, and can provide improved signal integrity performance, while reducing an amount of material required to form the housing 106. By exposing the coaxial adaptor 133, the window 187 can allow for visual inspection and verification of proper component placement during assembly or maintenance. Moreover, the presence of the window 187 can reduce an amount of dielectric material surrounding the coaxial adaptor 133, which can help minimize signal distortion and losses. This can be important for high-frequency applications where maintaining signal quality is critical.

Referring again to FIGS. 9-11, the legs 145a, 145b of the locking device 109 can include hooked regions 190 that can prevent the locking device 109 from being fully removed from the housing 106 without substantial force, while also allowing vertical adjustment of the locking device 109. The hooked regions 190 can engage with corresponding stops 193a, 193b (collectively “stops 193”) located on one or both sides of the housing 106. As such, the hooked regions 190 can also enable the locking device 109 to form a snap connection, where the hooked regions 190 can snap into the second, secure position shown in FIG. 15. This configuration can provide flexibility in adjusting and securing the locking device 109 while maintaining a robust connection to the housing 106. The hooked regions 190 can allow for easy installation and removal when needed, but may also provide resistance against accidental disconnection during use. The vertical adjustability facilitated by the hooked regions 190 allow for accommodation of different cable thicknesses or assembly tolerances of the thin-film circuit 103. Additionally, the snap connection capability can provide tactile or audible feedback to confirm proper engagement of the locking device 109 in its secure or non-secure positions.

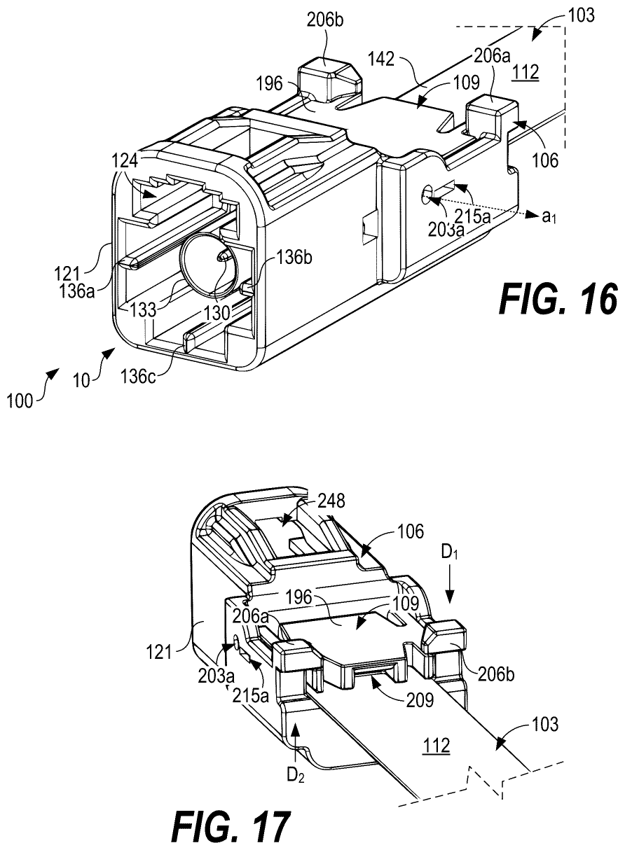

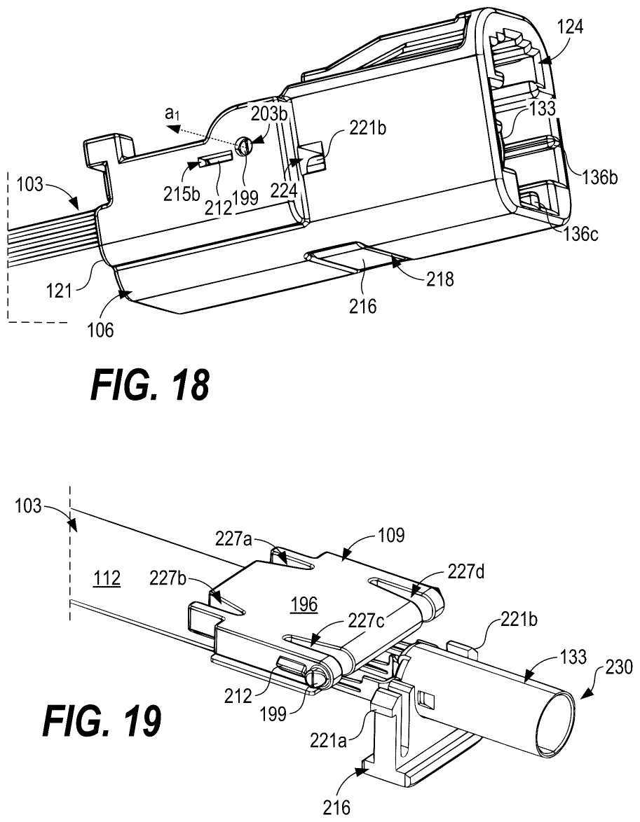

Turning now to FIGS. 16-18, another embodiment of the plug module 10 of the connector assembly 100 is shown according to various embodiments. More specifically, FIG. 16 shows a top, front perspective view of the plug module 10, FIG. 17 shows a top, rear perspective view of the plug module 10, and FIG. 18 shows a bottom, front perspective view of the plug module 10. The plug module 10 can be substantially similar to the plug module 10 described above, with some variations. For instance, the locking device 109 of the plug module 10 of FIGS. 16-18 includes a latch 196 that is pivotably coupled to the housing 106, where the latch 196 may facilitate detachably attaching the thin-film circuit 103 to the housing 106. In some embodiments, the latch 196 acts as a compression lid, compressing the thin-film circuit 103 to the housing 106. To this end, the latch 196 may enable installation and removal of the thin-film circuit 103.

The latch 196 includes a body having pivot projections 199 positioned on opposing sides thereof that are configured to nest and rotate within corresponding apertures 203a, 203b (collectively “apertures 203”) positioned on opposing sides of the housing 106. The pivot projections 199 are thus rotationally positioned in the apertures 203, enabling the latch 196 to rotate upwards and downwards, and rotate about an axis a₁. The latch 196 of the plug module 10 is shown in a closed, locked position in FIGS. 16-18. It is understood, however, that the latch 196 may rotate about the axis a₁ to transition to an open, unlocked state, where the thin-film circuit 103 may be detached from the housing 106, as will be described.

The housing 106 includes retention members 206a, 206b (collectively “retention members 206”) positioned on opposing sides of the housing 106 that may retain the latch 196 relative to the housing 106. The retention members 206 may be integral with the housing body 121, and may be positioned on a rear end (e.g., a termination end) of the housing 106. The retention members 206 may also be positioned on opposing sides of the housing 106. The retention members 206 may extend vertically along opposing sides of the latch 196 such that the latch 196 is at least partially nested between and/or below the retention members 206. To this end, the retention members 206 may include a portion overlapping a top of the latch 196 when the latch 196 is in the closed position. The portion overlapping the top of the latch 196 and/or a vertical portion of the retention members 206 may deflect when force is applied against the latch 196. As such, the retention members 206 may retain the latch 196 in its closed position, creating a snap or interference connection between a body of the latch 196 and the retention members 206.

It is understood that a predetermined amount of force in a downward direction D₁ will cause the latch 196 to engage with the retention members 206, causing the retention members 206 to flex or deform, and permit the latch 196 to force itself to the position shown in FIGS. 16-18. A predetermined amount of force in an upward direction D₂ will cause the latch 196 to disengage from the connection with the retention members 206, and permit the latch 196 to freely rotate about the axis a₁. The latch 196 may include an insert 209 which facilitates placement of a digit or leverage device to apply force in the upward direction D₂ and dislodge the latch 196 from its connection with the retention members 206.

In addition to the pivot projections 199, the latch 196 may further include flanges 212 positioned on opposing sides of the latch 196 proximal the pivot projections 199. The flanges 212 may be configured to snap into flange apertures 215a, 215b (collectively “flange apertures 215”) positioned on the housing 106 of the plug module 10. The flange apertures 215 can be elongated and rectangular shaped, and the flanges 212 can be sized and positioned to snap into and form an interference connection with the flange apertures 215. The predetermined amount of force in the upward direction D₂ will further cause the latch 196 to disengage from the connection with the retention members 206 as well as the flange apertures 215, and permit the latch 196 to freely rotate about the axis a₁. In some embodiments, the flanges 212 are positioned proximate the pivot projections 199. However, in alternative embodiments, the flanges 212 can be positioned at other locations along the latch 196 or sidewalls thereof.

The plug module 10 of FIGS. 16-18 also includes first and second alignment guides 136a, 136b situated in the front aperture 124 on opposing inner walls of the housing 106. A third alignment guide 136c is situated on a bottom inner wall of the housing 106. The alignment guides 136 may each slide into corresponding slots or apertures on a receptacle module (not shown), creating a snug fit between the plug module 10 and a housing of the receptacle module, as will be described.

In some embodiments, the plug module 10 includes a coaxial support 216, shown in FIGS. 18 and 19. Specifically, FIG. 19 is another bottom perspective view of the plug module 10; however, the housing 106 thereof is omitted for explanatory purposes and to illustrate the coaxial support 216. The coaxial support 216 may be inserted or otherwise positioned through a bottom insert aperture 218 on a bottom of the housing 106, and may engage with the housing 106 via insert tabs 221a, 221b (collectively “insert tabs 221”).

In some embodiments, the coaxial support 216 is positioned through the bottom insert aperture 218 until the insert tabs 221 form a snap connection with the housing body 121 or apertures 224 positioned on opposing sidewalls of the housing body 121, as shown in FIG. 18. The coaxial support 216 may extend into the front aperture 124, and may provide a support for the coaxial adaptor 133. For instance, the coaxial adaptor 133 may be positioned on the coaxial support 216 in a cantilevered arrangement. The placement of the coaxial adaptor 133 may define the insertion depth of the coaxial adaptor 133 into a corresponding adaptor of an external connector. In some embodiments, the coaxial support 216 is formed of a non-conductive polymer material. However, the material of the coaxial support 216 is not limited to non-conductive polymer materials, and other materials may be employed. FIG. 19 further illustrates the geometry of the latch 196, which can be generally square or rectangular, and may feature one or more V-shaped cut-outs 227a . . . 227d (collectively “cut-outs 227”) that minimize an amount of material necessary for the latch 196, and facilitate deformation of the latch 196, for instance, to attach to or detach from the housing body 121. A coaxial adaptor assembly 230 is further shown in FIG. 19, as will be described.

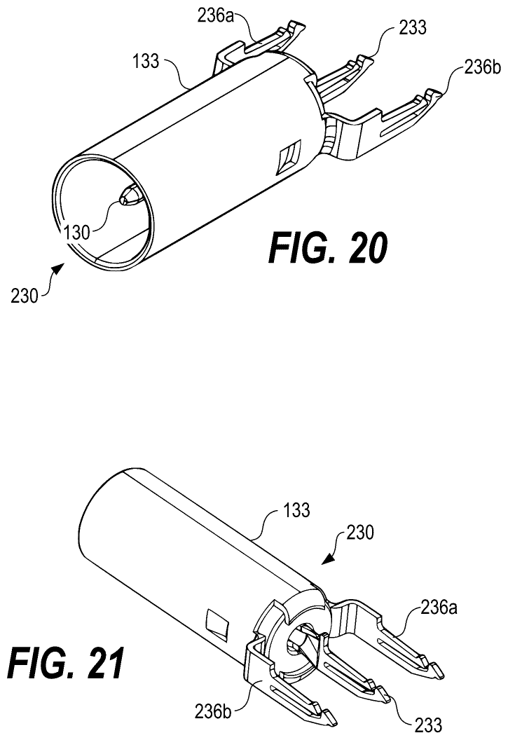

FIGS. 20 and 21 illustrate top-front and bottom-rear perspective views, respectively, of the coaxial adaptor assembly 230 of the plug module 10 of FIG. 16 according to various embodiments of the present disclosure. The coaxial adaptor assembly 230 includes the coaxial adaptor 133 and the conductor 130. A signal terminal 233 extends from a rear end of the conductor 130, and is electrically coupled to the conductor 130 for transmission of a signal. Ground terminals 236a, 236b (collectively “ground terminals 236”) extend from a body of the coaxial adaptor 133, where the signal terminal 233 is positioned between a pair of the ground terminals 236. The ground terminals 236 may be coupled to the ground paths 118 (FIG. 1) on the thin-film circuit 103, and the signal terminal 233 may be coupled to the signal path 115 (FIG. 1) on the thin-film circuit 103, as can be appreciated.

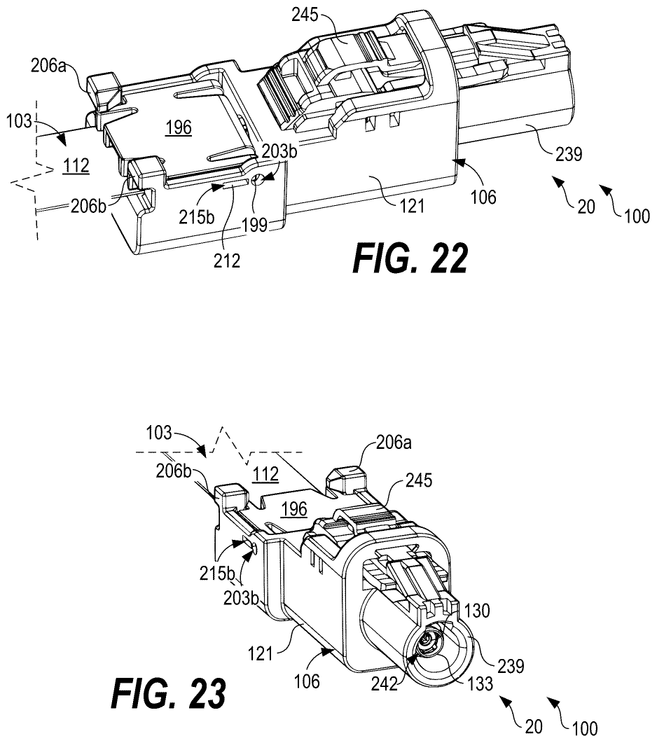

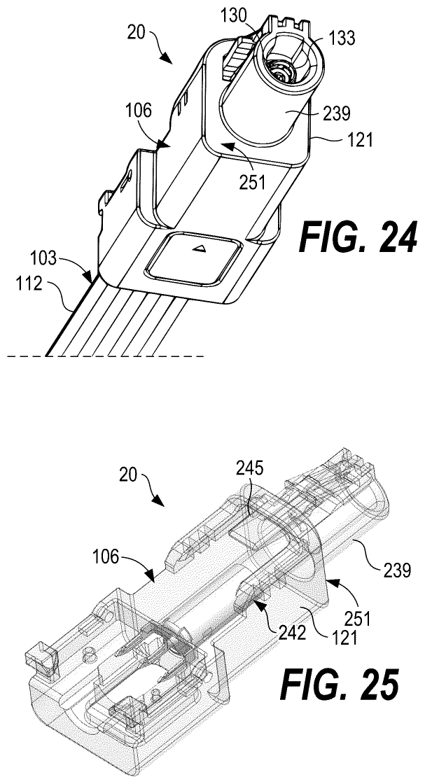

FIGS. 22-25 show perspective views of a receptacle module 20 of the connector assembly 100 for coupling to the various embodiments of the plug module 10 described herein. The receptacle module 20 may include various similar or identical components of the plug module 10. For instance, the receptacle module 20 can include the latch 196, the thin-film circuit 103, and a housing 106 having a housing body 121. However, the housing 106 may have a different configuration from that of the plug module 10. For instance, the housing 106 of FIGS. 22-25 may include an elongated tubular projection portion 239 having a coaxial adaptor assembly 242 configured to mate with the coaxial adaptor assembly 230 of the plug module 10 such that the conductors 130 thereof are in data communication.

The body 121 of the housing 106 may include locating features to engage with the housing 106 of the plug module 10 and form a snap connection or interference connection. For instance, a housing latch 245 may releasably insert into a housing latch aperture 248 (FIG. 17) in the housing 106 of the plug module 10 to retain the coupling between the plug module 10 and the receptacle module 20, where the housing latch 245 can be disengaged to release the plug module 10 from the receptacle module 20. A ridge 251 located on a front face of the housing 106 of the receptacle module 20 may prevent over-mating and/or over-insertion of the receptacle module 20 relative to the plug module 10, creating a stopping surface that contacts a front surface on the housing 106 of the plug module 10.

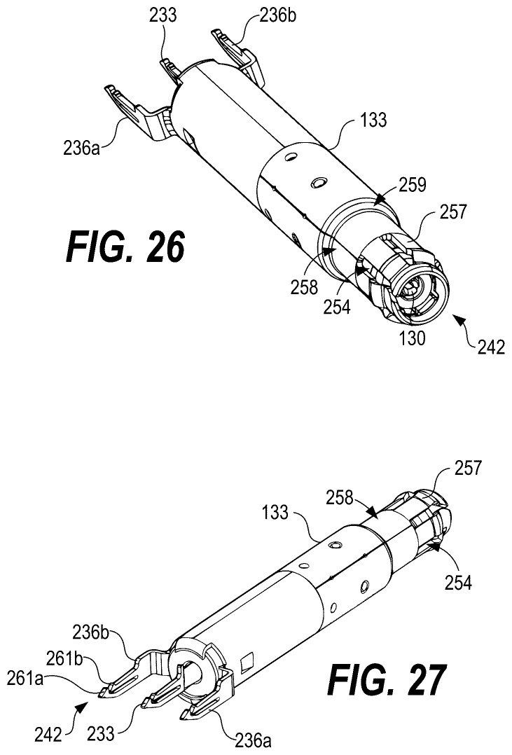

FIGS. 26 and 27 illustrate front and rear perspective views, respectively, of the coaxial adaptor assembly 242 of the receptacle module 20 according to various embodiments of the present disclosure. The coaxial adaptor assembly 242 includes the coaxial adaptor 133 and the conductor 130, which may, in some implementations, include a female-styled conductor receptacle configured to receive a male-styled conductor of the plug module 10. A signal terminal 233 extends from a rear end of the conductor 130, and is configured to electrically couple to the conductor 130 for transmission of a signal. Ground terminals 236a, 236b extend from a body of the coaxial adaptor 133, where the signal terminal 233 is positioned between the ground terminals 236a, 236b. The ground terminals 236a, 236b may be coupled to the ground paths 118 on the thin-film circuit 103, and the signal terminal 233 may be coupled to the signal path 115 on the thin-film circuit 103.

The coaxial adaptor 133 of the receptacle module 20 may include slots 254 extending annularly around its body, where the slots 254 define compliant fingers 257. The compliant fingers 257 may be elastic or have some deformation upon contact with a force. As such, the compliant fingers 257 may be configured to insert into and create an interference connection with the coaxial adaptor 133 of the plug module 10 when the plug module 10 and the receptacle module 20 are mated together. The slots 254 may extend longitudinally along a portion of the coaxial adaptor 133, thereby allowing the compliant fingers 257 to flex radially inward or outward to accommodate the coaxial adaptor 133 of the plug module 10.

In some aspects, the compliant fingers 257 may provide a spring force that maintains contact pressure between the coaxial adaptors 133 of the plug module 10 and the receptacle module 20, which facilitates reliable electrical connectivity and signal transmission between the modules 10, 20. The interference connection formed by the compliant fingers 257 may also provide mechanical retention between the plug module 10 and the receptacle module 20, supplementing the retention provided by the housing latch 245 and other locating features.

In some embodiments, the coaxial adaptor 133 of the receptacle module 20 may include an insertion section 258 configured for insertion into the coaxial adaptor 133 of the plug module 10. In other implementations, the coaxial adaptor 133 of the plug module 10 may include the insertion section 258 configured for insertion into the coaxial adaptor 133 of the receptacle module 20. The insertion section 258 may have an outer diameter that is less than an outer diameter of a remainder of the coaxial adaptor 133 or other downstream section thereof. A larger diameter of a downstream section of the coaxial adaptor 133 may prevent over-mating or over-insertion of the coaxial adaptors 133 during coupling of the plug module 10 and the receptacle module 20. For instance, when the insertion section 258 is fully inserted into the corresponding coaxial adaptor 133, a shoulder 259 or transition region between the insertion section 258 and the larger diameter portion of the coaxial adaptor 133 may contact a mating surface of the receiving coaxial adaptor 133, thereby limiting further insertion.

In some embodiments, the terminals of the coaxial adaptor assembly 242, including the signal terminal 233 and the ground terminals 236a, 236b shown in FIGS. 26 and 27, may be of a dual-fork configuration such that each terminal provides two points of contact 261a, 261b to the respective signal path 115 and ground paths 118 of the thin-film circuit 103. Similarly, the signal terminal 233 and the ground terminals 236a, 236b of the coaxial adaptor assembly 230 shown in FIGS. 20 and 21 may be configured to provide two points of contact to the corresponding paths on the thin-film circuit 103. The biasing force applied by the latch 196 when in the closed position may compress the thin-film circuit 103 against the contact points at the two locations, which may facilitate electrical connectivity between the terminals and the conductive paths positioned along a bottom surface of the thin-film circuit 103.

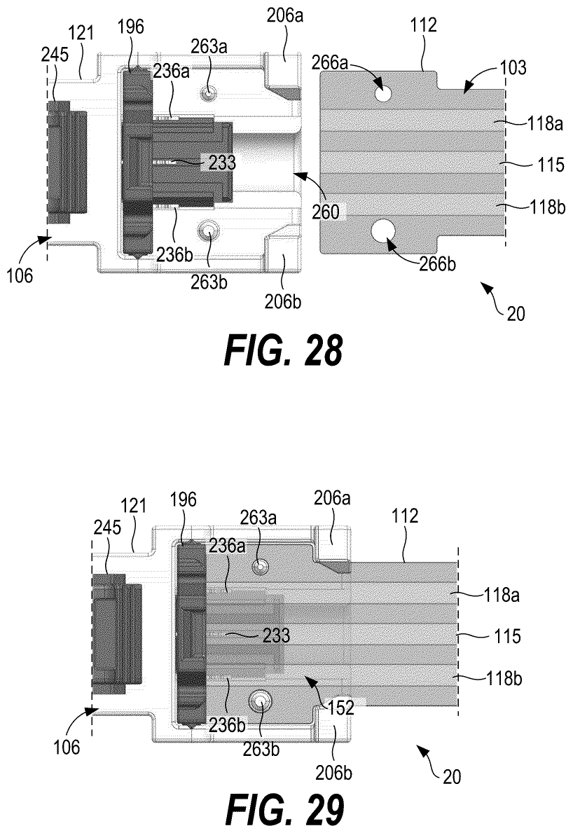

FIGS. 28 and 29 illustrate top views of the receptacle module 20 showing the thin-film circuit 103 in decoupled and coupled states, respectively, according to various embodiments of the present disclosure. More specifically, FIG. 28 is a top view of the housing 106 of the receptacle module 20, where the thin-film circuit 103 is shown as being removed or decoupled from the housing 106. FIG. 29 shows the thin-film circuit 103 being coupled to the receptacle module 20 with the latch 196 being in an open, non-secured position.

Referring to FIGS. 28 and 29, retention members 206 are shown at a rear of the housing 106 of the receptacle module 20. The housing 106 further includes a mating channel 260 in which a portion of the thin-film circuit 103 is positioned when the thin-film circuit 103 is coupled to the receptacle module 20. Alignment and retention posts 263a, 263b (collectively “alignment and retention posts 263” or “posts 263”) extend upwards from a bottom surface of the mating channel 260. The posts 263 are configured to insert into circuit apertures 266a, 266b (collectively “circuit apertures 266”) positioned on opposing sides of the body 112 of the thin-film circuit 103. In some aspects, the posts 263 may facilitate proper alignment of the thin-film circuit 103 relative to the housing 106, and may provide retention to maintain the position of the thin-film circuit 103 within the mating channel 260.

The latch 196 may then latch down on the termination region 152 of the thin-film circuit 103, and provide a compression force against the thin-film circuit 103. The terminals 233, 236 are exposed in the mating interface within the mating channel 260. The compression force provided by the latch 196 may facilitate a coupling of the signal path 115 of the thin-film circuit 103 with the signal terminal 233, and the ground paths 118 of the thin-film circuit 103 with the ground terminals 236. In some embodiments, the compression force may ensure reliable electrical contact between the conductive paths of the thin-film circuit 103 and the corresponding terminals of the coaxial adaptor assembly 242.

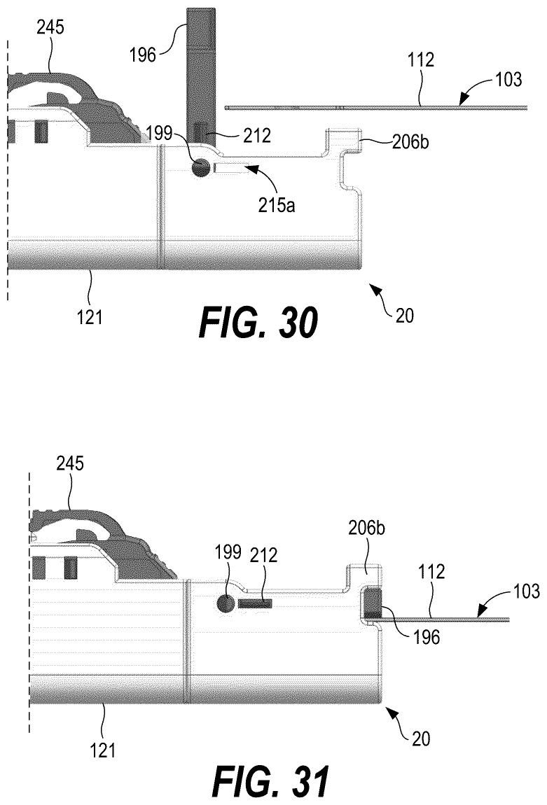

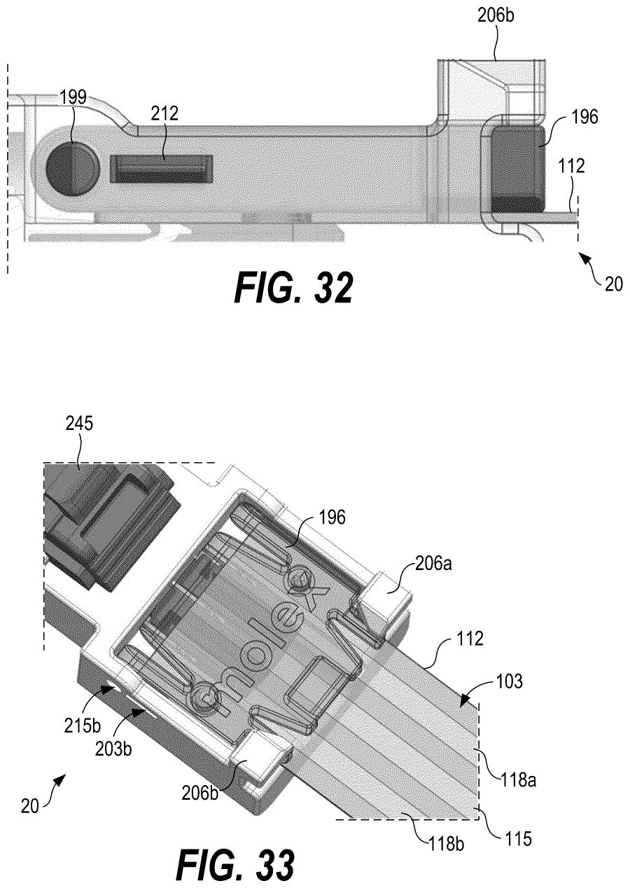

FIGS. 30-32 illustrate various side views of the receptacle module 20 according to various embodiments of the present disclosure. FIG. 33 is a top perspective view of the mating interface of the receptacle module 20. In FIG. 30, the thin-film circuit 103 is shown as removed or disengaged from the housing 106 of the receptacle module 20, and the latch 196 is in an open position. The latch 196 is rotated upwardly about the axis a₁, exposing the mating channel 260 and the terminals 233, 236 positioned therein. The pivot projections 199 are positioned within corresponding apertures 203 (FIG. 18) on the housing 106 to enable rotational movement of the latch 196.

While operation of the latch 196 and termination of the thin-film circuit 103 is illustrated with respect to the receptacle module 20, it is understood that a similar or identical operation of the latch 196 and termination of the thin-film circuit 103 can be made on the plug module 10. For instance, the plug module 10 may include the latch 196 that pivots about the axis a₁ between open and closed positions, where the latch 196 applies a compression force against the termination region 152 of the thin-film circuit 103 when in the closed position. The plug module 10 may similarly include the mating channel 260, the alignment and retention posts 263, and the circuit apertures 266 to facilitate alignment and retention of the thin-film circuit 103 relative to the housing 106. In some aspects, the terminals 233, 236 of the coaxial adaptor assembly 230 of the plug module 10 may be exposed in the mating channel 260, and the compression force provided by the latch 196 may facilitate coupling of the signal path 115 and the ground paths 118 of the thin-film circuit 103 with the signal terminal 233 and the ground terminals 236, respectively.

In FIGS. 31-33, the thin-film circuit 103 is in an installed position within the housing 106 of the receptacle module 20, and the latch 196 is in a closed state. In this configuration, the latch 196 applies a downward compression force against the termination region 152 of the thin-film circuit 103. The compression force biases or urges the conductive signal paths 115, 118 of the thin-film circuit 103 into contact with the corresponding terminals of the coaxial adaptor assembly 242 (FIG. 25). The flanges 212 of the latch 196 may be engaged with the flange apertures 215 on the housing 106, and the retention members 206 may retain the latch 196 in the closed position. The pivot projections 199 are positioned within the corresponding apertures 203 on the housing 106, providing a rotational axis about which the latch 196 transitions between the open and closed states.

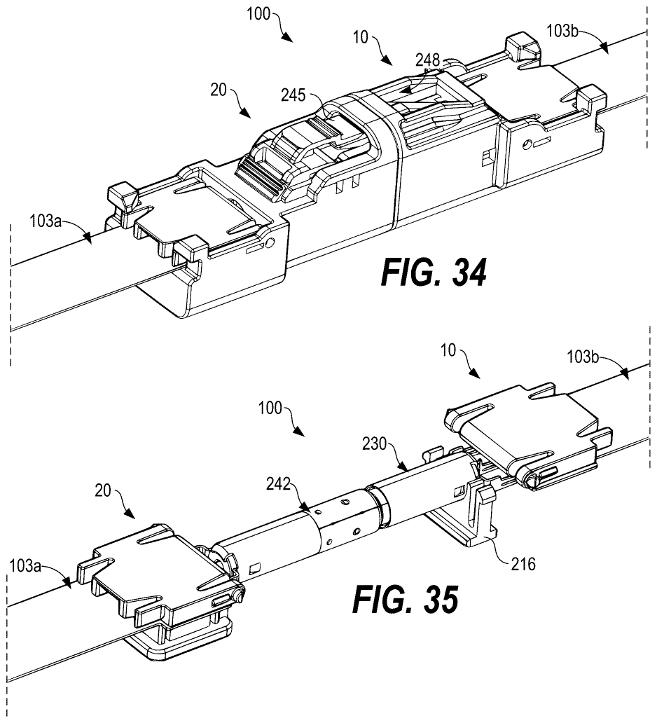

Turning now to FIGS. 34 and 35, FIG. 34 shows the connector assembly 100, where the plug module 10 is detachably coupled to the receptacle module 20 according to various embodiments of the present disclosure. FIG. 35 is an identical view of FIG. 34 with the housings 106 of the plug module 10 and the receptacle module 20 omitted to display connections between respective coaxial adaptor assemblies 230, 242 of the plug module 10 and the receptacle module 20.

Referring to FIG. 34, the housing latch 245 of the receptacle module 20 is shown as being inserted into the housing 106 of the plug module 10, creating a detachable but fixed connection between the plug module 10 and the receptacle module 20. The housing latch 245 may engage with the housing latch aperture 248 on the housing 106 of the plug module 10 to retain the mated configuration of the connector assembly 100. This arrangement may permit the plug module 10 and the receptacle module 20 to be separated when a predetermined amount of force is applied, while maintaining a secure connection during operation.

Referring to FIG. 35, the coaxial adaptor assembly 230 of the plug module 10 is shown in mated engagement with the coaxial adaptor assembly 242 of the receptacle module 20. The conductors 130 of the respective coaxial adaptor assemblies 230, 242 are positioned in electrical communication with one another, enabling signal transmission between the plug module 10 and the receptacle module 20. The compliant fingers 257 (FIG. 26) of the coaxial adaptor 133 of the receptacle module 20 may engage with the coaxial adaptor 133 of the plug module 10 to form an interference connection therebetween.

The connection between the plug module 10 and the receptacle module 20 enables a connection between two thin-film circuits 103a, 103b (collectively “thin-film circuits 103”), where signals may be transmitted along the signal paths 115 and ground paths 118 of the respective thin-film circuits 103 through the mated coaxial adaptor assemblies 230, 242. It is understood, however, that other types of cables or substrates may be employed in place of or in addition to the thin-film circuits 103, such as ribbon cables, coax cables, twinax cables, and so on.

As discussed, the connector assembly 100 may be configured for termination of thin-film substrates to the modules 10, 20, including the thin-film circuit 103 described herein. The connector assembly 100 may provide performance up to 8.0 GHz, with return loss and insertion loss characteristics that may be suitable for antenna applications. For instance, the configuration and the geometry of the coaxial adaptor assemblies 230, 242 and the impedance characteristics of the thin-film circuit 103 may contribute to signal integrity at higher frequencies.

The connector assembly 100 may be field serviceable and field replaceable. The latch 196 and locking device 109 configurations described herein may allow technicians to install, remove, and replace the thin-film circuit 103 without specialized tooling. In some cases, this may facilitate maintenance and repair operations in field environments including, but not limited to, automotive environments. In some implementations, the connector assembly 100 may enable antenna integration into windshields or other glass surfaces. For instance, the thin-film circuit 103 may be incorporated into a glass manufacturing process, where the connector assembly 100 provides an interface between the antenna elements embedded in the glass and external electronic components.

The mating interfaces of the plug module 10 and the receptacle module 20 may be compatible with common automotive connector interfaces. In some aspects, the connector assembly 100 may be configured to mate with HFM and Mate-Ax connector systems commonly used in automotive applications. The plug module 10 and the receptacle module 20 of the connector assembly 100 may be provided to accommodate various connection configurations. In some cases, this may allow flexibility in connecting telematics control units (TCUs) and extender cables, where either the plug module 10 or the receptacle module 20 may be selected based on the specific application requirements.

The termination contacts, including the signal terminal 233 and the ground terminals 236, may utilize contact designs employed in automotive applications. In some embodiments, the termination contacts may include two independent contact points, which may provide connection redundancy. The crimping portions 163 extending through the trace apertures 160 may establish multiple points of electrical contact between the coaxial adaptor assemblies 230, 242 and the conductive paths of the thin-film circuit 103. In some aspects, the connector assembly 100 may include terminal position assurance (TPA) features for both the plug module 10 and the receptacle module 20. The coaxial support 216 and associated retention features may provide coaxial core position assurance, helping to maintain proper positioning of the conductor 130 within the coaxial adaptor 133 during assembly and operation.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures. When two components are described as being “coupled to” each other, the components can be electrically coupled to each other, with or without other components being electrically coupled and intervening between them. When two components are described as being “directly coupled to” each other, the components can be electrically coupled to each other, without other components being electrically coupled between them.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A connector assembly, comprising:
a plug module, comprising:
a thin-film circuit comprising a flexible body having a signal path and at least one ground path disposed thereon;
a coaxial adaptor assembly comprising a conductor and a coaxial adaptor, wherein the signal path of the thin-film circuit is conductively coupled to the conductor;
a housing having a front aperture in which the conductor is positioned, the housing comprising a mating end and a termination end; and
a latch pivotably coupled to the housing at the termination end, the latch being adjustable between an open position in which the thin-film circuit is releasable from the housing, and a closed position in which the latch applies a compression force against the thin-film circuit to secure the thin-film circuit to the housing.

2. The connector assembly of claim 1, wherein the latch comprises pivot projections positioned on opposing sides thereof, and wherein the housing comprises apertures configured to receive the pivot projections to enable rotational movement of the latch between the open position and the closed position.

3. The connector assembly of claim 1, wherein the housing comprises retention members positioned on opposing sides of the housing, the retention members being configured to retain the latch in the closed position.

4. The connector assembly of claim 1, wherein the latch comprises flanges positioned on opposing sides thereof, and wherein the housing comprises flange apertures configured to receive the flanges when the latch is in the closed position.

5. The connector assembly of claim 1, further comprising a coaxial support positioned through a bottom insert aperture on a bottom of the housing, the coaxial support extending into the front aperture and providing support for the coaxial adaptor.

6. The connector assembly of claim 5, wherein the coaxial support comprises insert tabs configured to form a snap connection with the housing.

7. The connector assembly of claim 1, wherein the coaxial adaptor assembly comprises a signal terminal extending from the conductor and ground terminals extending from the coaxial adaptor, the signal terminal being conductively coupled to the signal path and the ground terminals being conductively coupled to the at least one ground path.

8. The connector assembly of claim 1, wherein the housing comprises alignment guides positioned within the front aperture, the alignment guides configured to engage with corresponding features of a receptacle module to facilitate mating of the plug module with the receptacle module.

9. The connector assembly of claim 1, wherein the housing comprises alignment and retention posts extending from a surface of a mating channel positioned at the termination end of the housing, and wherein the flexible body of the thin-film circuit comprises circuit apertures configured to receive the alignment and retention posts.

10. A connector assembly, comprising:
a receptacle module, comprising:
a thin-film circuit comprising a flexible body having a signal path and at least one ground path disposed thereon;
a coaxial adaptor assembly comprising a conductor receptacle disposed within a coaxial adaptor, wherein the signal path of the thin-film circuit is conductively coupled to the conductor receptacle, and wherein the at least one ground path is conductively coupled to the coaxial adaptor;
a housing having a front aperture in which the coaxial adaptor and the conductor receptacle are positioned, the housing comprising a mating end and a termination end; and
a latch pivotably coupled to the housing at the termination end, the latch being adjustable between an open position in which the thin-film circuit is releasable from the housing, and a closed position in which the latch applies a compression force against the thin-film circuit to secure the thin-film circuit to the housing.

11. The connector assembly of claim 10, wherein the coaxial adaptor comprises slots extending annularly around a body thereof, the slots defining compliant fingers configured to form an interference connection with a coaxial adaptor of a plug module when the receptacle module is mated with the plug module.

12. The connector assembly of claim 11, wherein the slots extend longitudinally along a portion of the coaxial adaptor, thereby allowing the compliant fingers to flex radially to accommodate the coaxial adaptor of the plug module.

13. The connector assembly of claim 10, wherein the housing comprises a mating channel in which a portion of the thin-film circuit is positioned, and wherein the housing further comprises alignment and retention posts extending from a surface of the mating channel, the alignment and retention posts configured to insert into circuit apertures positioned on opposing sides of the flexible body of the thin-film circuit.

14. The connector assembly of claim 10, wherein the housing comprises a housing latch configured to releasably insert into a housing latch aperture of a plug module to retain a coupling between the receptacle module and the plug module.

15. The connector assembly of claim 10, wherein the housing comprises an elongated tubular projection portion having the coaxial adaptor assembly positioned therein, the elongated tubular projection portion configured to mate with a front aperture of a plug module.

16. A connector assembly, comprising:
a plug module, comprising:
a first thin-film circuit comprising a first flexible body having a first signal path and at least one first ground path disposed thereon;
a first coaxial adaptor assembly comprising a first conductor and a first coaxial adaptor, wherein the first signal path is conductively coupled to the first conductor; and
a first housing having a first front aperture in which the first conductor is positioned; and
a receptacle module detachably attachable to the plug module, the receptacle module comprising:
a second thin-film circuit comprising a second flexible body having a second signal path and at least one second ground path disposed thereon;
a second coaxial adaptor assembly comprising a conductor receptacle and a second coaxial adaptor, wherein the second signal path is conductively coupled to the conductor receptacle; and
a second housing having a second front aperture in which the second coaxial adaptor is positioned, the second coaxial adaptor configured to mate with the first coaxial adaptor to establish electrical communication between the first conductor and the conductor receptacle,
wherein at least one of the plug module and the receptacle module comprises a latch pivotably coupled to a respective housing, the latch being adjustable between an open position in which a respective thin-film circuit is releasable from the respective housing, and a closed position in which the latch applies a compression force against the respective thin-film circuit to secure the respective thin-film circuit to the respective housing.

17. The connector assembly of claim 16, wherein the second coaxial adaptor comprises compliant fingers configured to form an interference connection with the first coaxial adaptor when the plug module is mated with the receptacle module.

18. The connector assembly of claim 16, wherein the second housing comprises a housing latch configured to releasably engage with a housing latch aperture on the first housing to retain the plug module and the receptacle module in a mated configuration.

19. The connector assembly of claim 16, wherein the first housing comprises alignment guides positioned within the first front aperture, and wherein the second housing comprises guide slots configured to receive the alignment guides to facilitate alignment of the plug module with the receptacle module during mating.

20. The connector assembly of claim 16, wherein the latch comprises pivot projections positioned on opposing sides thereof configured to nest within corresponding apertures on the respective housing, and wherein the respective housing comprises retention members configured to retain the latch in the closed position.
